(19) United States
(12) Patent Application Publication
(10) Pub. No.: US 2010/0226516 A1
(43) Pub. Date: Sep. 9, 2010

(54) METHOD FOR OPERATING A HEARING APPARATUS, COMPUTER PROGRAM PRODUCT FOR IMPLEMENTING THE METHOD AND HEARING APPARATUS WITH FEEDBACK SUPPRESSION

(75) Inventors: Alexander Grafenberg, Effeltrich (DE); Johannes Lauer, Baiersdorf (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/719,097

(22) Filed: Mar. 8, 2010

(30) Foreign Application Priority Data
Mar. 6, 2009 (DE) 10 2009 012 162.5

(51) Int. Cl. H04R 25/00

(52) U.S. Cl. 381/318

(57) ABSTRACT

A method for operating a hearing apparatus includes determining feedback events, in which feedback suppression responds and/or in which feedback is detected above a predeterminable feedback threshold value, determining a frequency of the feedback events within a predeterminable duration and emitting a signal if the determined frequency exceeds a predeterminable frequency threshold value. A time instant for changing an earmold which is no longer optimally positioned and is the cause of a frequent feedback can therefore be advantageously predicted in a timely manner. A computer program product for implementing the method and a hearing apparatus with acoustic feedback suppression and/or acoustic feedback identification, are also provided.

### CROSS-REFERENCE TO RELATED APPLICATION

This application claims the priority, under 35 U.S.C. §119, of German Patent Application 10 2009 012 162.5, filed Mar. 6, 2009; the prior application is herewith incorporated by reference in its entirety.

### BACKGROUND OF THE INVENTION

### Field of the Invention

The invention relates to a method for operating a hearing apparatus with feedback suppression which responds upon occurrence of an acoustic feedback and/or an acoustic feedback identification. The invention also relates to a computer program product with a computer program having software for implementing a method according to the invention, if the computer program is executed in a control unit. The invention further relates to a hearing apparatus with a feedback suppression unit which responds upon occurrence of an acoustic feedback and/or an acoustic feedback identification unit.

If couplings exist in a signal processing system of a hearing apparatus between inputs and outputs (e.g. acoustic, electromagnetic, electric, magnetic, etc.), feedback effects may occur. One example of such a configuration is a hearing device 1 reproduced in schematic and block form in FIG. 1. The hearing device can reproduce a digital system 10, which is located in acoustic surroundings. An incoming acoustic signal 9 is recorded by a microphone 2 of the hearing device 1. The recorded signal 9 is, inter alia, amplified in a signal processing unit 6 and output again by way of a receiver 3. An acoustic coupling from the receiver 3 back to the microphone 2 takes place by way of a physical feedback path 4. The recorded signal 9 is therefore formed of the total of an incoming useful signal 8 and the signal by way of the feedback path 4. As a result of the feedback, feedback whistling occurs if both the amplitude and also the phase condition are fulfilled. Sound artifacts nevertheless already occur if the above conditions are only approximately fulfilled.

In order to suppress the feedback effects, a method is known in which the physical feedback path 4 is reproduced digitally. The reproduction takes place through the use of an adaptive filter 5, which is supplied by the receiver signal. After filtering in the adaptive compensation filter 5, the receiver signal is subtracted from the microphone signal in an adder 7.

Two paths therefore exist in the system, on one hand the physically existing feedback path 4 and on the other hand the digital compensation path reproduced by way of the adaptive filter 5. Since the resulting signals of the two paths are subtracted from one another at the input of the device, the effect of the physical feedback path 4 is ideally cancelled.

In the case of a hearing device, an acoustic feedback is substantially influenced by the fit accuracy of an earmold located in the auditory canal. With a poor fit, sound waves can pass through the earmold to a hearing device microphone and therefore generate unwanted feedback. The form of the auditory canal, for instance size, curvature, condition, is subject to temporal changes, for instance in the case of children during growth or adults as a result of the changes to the connective tissue of the ear. That results in custom-made ear molds no longer ensuring adequate fit accuracy after a certain period of wear and acoustic feedback occurring more frequently as a result.

The acoustic feedback is suppressed in modern hearing devices through the use of signal processing (feedback cancellation). That electronic measure only takes effect if feedback already occurs. Feedback suppression methods also include a physically determined limit. In the initial fit accuracy stage of the earmold piece, the feedback suppression method is very reliable. A hearing device wearer only then seeks a hearing device acoustician if the hearing device produces feedback frequently or continuously. In particular, for those in need of care and children, who possibly communicate with more difficulty, that behavior of the hearing device is unsatisfactory.

### SUMMARY OF THE INVENTION

It is accordingly an object of the invention to provide a method for operating a hearing apparatus, a computer program product for implementing the method and a hearing apparatus with feedback suppression, which overcome the hereinafore-mentioned disadvantages of the heretofore-known methods, products and apparatuses of this general type.

With the foregoing and other objects in view there is provided, in accordance with the invention, a method for operating a hearing apparatus with feedback suppression, which responds upon occurrence of an acoustic feedback and/or an acoustic feedback identification. The method comprises the following steps:

determining feedback events, in which the feedback suppression responds and/or in which a feedback is detected above a predeterminable feedback threshold;

determining the frequency of the feedback events within a predeterminable time duration; and

outputting a signal if the determined frequency exceeds a predeterminable frequency threshold.

This is advantageous in that a time instant for changing an earmold which is no longer optimally positioned in the ear canal and is the cause of a frequent feedback can be predicted in a timely manner.

In accordance with another mode of the invention, the frequency threshold value is less than a predeterminable acceptance value, with the frequency threshold value being determined from an interpolation of the acceptance value. As a result, a robust estimation of the achievement of the acceptance threshold is possible.

In accordance with a further mode of the invention, the interpolation can be performed with the aid of a frequency distribution of the feedback events as a function of time, with the frequency distribution up to the acceptance value being extrapolated. This advantageously provides for a simple prediction as to when the acceptance value is likely to be achieved.

In accordance with an added mode of the invention, the method includes determining an interaction time instant on the basis of the curve of the frequency, during which the acceptance value is probably achieved.

In accordance with an additional mode of the invention, the signal can be emitted acoustically or optically. As a result, a simple and clear communication to the user or person caring for a user is ensured.

With the objects of the invention in view, there is also provided a computer program product with a computer program, comprising software for implementing the method according to the invention, if the computer program is executed in a control unit.

With the objects of the invention in view, there is furthermore provided a hearing apparatus with a feedback suppression unit, which responds upon the occurrence of an acoustic feedback and/or an acoustic feedback identification unit. The hearing apparatus comprises:

an event unit for determining feedback events, in which the feedback suppression responds and/or in which a feedback can be detected above a predeterminable feedback threshold value;

a computing unit for determining the frequency of the feedback events within a predeterminable time period; and

a signal unit for emitting a signal if the determined frequency exceeds a predeterminable frequency threshold value.

In accordance with another feature of the invention, the frequency threshold value is less than a predeterminable acceptance value, with the frequency threshold value being determinable from an interpolation of the acceptance value in the computing unit.

In accordance with a further feature of the invention, the interpolation can be implemented in the computing unit with the aid of a frequency distribution of the feedback events as a function of time, with the frequency distribution being extrapolated up to the acceptance value.

In accordance with an added feature of the invention, the computing unit can determine an interaction time instant, in which the acceptance value is likely to be achieved, with the aid of the curve of the frequency.

In accordance with an additional feature of the invention, the signal can be emitted acoustically or optically through the use of the signal unit.

In accordance with yet another feature of the invention, the hearing apparatus can include a remote controller, with the signal being emittable by way of the remote controller.

In accordance with a concomitant feature of the invention, the hearing apparatus can also include an in-the-ear hearing device.

Other features which are considered as characteristic for the invention are set forth in the appended claims.

Although the invention is illustrated and described herein as embodied in a method for operating a hearing apparatus, a computer program product for implementing the method and a hearing apparatus with feedback suppression, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block diagram illustrating feedback suppression;

FIG. 2 is a diagram showing the frequency of feedback events; and

FIG. 3 is a plan view of an in-the-ear hearing device according to the invention.

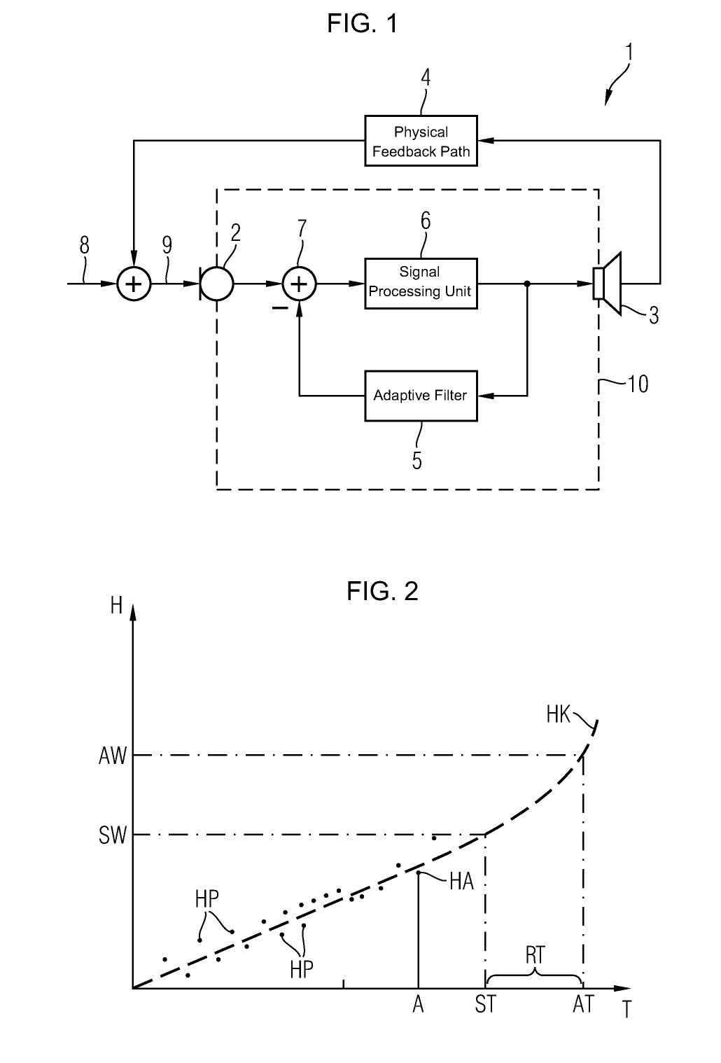

### DETAILED DESCRIPTION OF THE INVENTION

Referring now to the figures of the drawings in detail and first, particularly, to FIG. 2 thereof, there is seen a diagram of a frequency H of feedback events as a function of a time T, with the aid of which the method according to the invention will be graphically explained. A hearing apparatus with feedback suppression or feedback identification is needed. A feedback event may be a response of the feedback suppression or an identification of a feedback above a predeterminable feedback threshold value. In accordance with the invention, these events are counted and the frequency thereof HP is determined in a predeterminable time period. The time period can be a calendar day or, however, also only an hour, for instance. The determined frequencies HP are thus determined as a function of time, for instance the frequency per day or the frequency averaged per day from the hour values.

The frequencies HP are approximated by a frequency curve HK. The curve HK can also be extrapolated through a current day A, at which the last current frequency value HA exists, with the aid of empirical values or approximation methods. From a predeterminable frequency, a so-called acceptance value AW, the hearing apparatus feeds back so frequently or exceeds the predeterminable feedback threshold value so often, that it is unacceptable for a wearer of the hearing apparatus.

A time instant AT, at which the acceptance value AW will probably be reached, is determined as a result of the extrapolated curve HK. If the frequency HP now reaches a predeterminable threshold value SW, a time instant ST of which is some days or weeks before the time instant AT, a signal or a display of a residual time RT before the acceptance value AW is reached is output. The wearer of the hearing apparatus or his/her care giver therefore knows that a person skilled in the art must shortly be found in order to adjust the hearing apparatus.

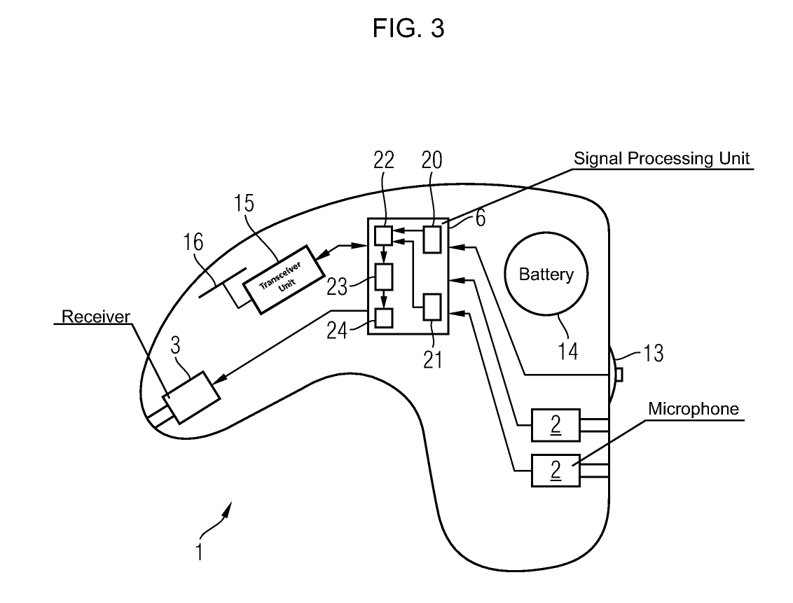

FIG. 3 shows a hearing device 1 which can be worn in the ear, along with its important components. A microphone 2, with a sound inlet opening for recording an acoustic signal, converts the recorded acoustic signal into an electrical signal. The electrical signal is fed to a signal processing unit 6 for further processing and frequency-dependent amplification purposes. The further processed and amplified signal is finally converted back from an electrical signal into an acoustic signal through the use of a receiver 3 and output into the auditory canal of a hearing device wearer by way of a sound channel. A battery 14 is used to supply power to the electrical components of the hearing device 1.

The hearing device 1 according to the exemplary embodiment can be adjusted in terms of its transmission characteristics to different hearing situations (e.g. “quiet environment,” “conversation,” “conversation in interference-prone surroundings,” “car travel,” etc.). The selection takes place through the use of adjusting certain parameter sets (hearing programs), which adjust the signal processing unit 6 to the respective hearing situation. A pushbutton 13 is used to toggle between the individual hearing programs.

As a further component, the hearing device 1 includes a transceiver unit 15 with an antenna 16 for the wireless exchange of data with a further hearing device for a binaural supply or with a remote controller and/or with an audio transmitter unit.

In order to suppress feedback, the hearing device 1 has a feedback suppression unit 20 and a feedback identification unit 21 in the signal processing unit 6 for suppressing and/or identifying acoustic feedback. If the fit accuracy of the hearing device 1 worsens over time, the frequency of the feedbacks increases. With the aid of an event unit 22 connected to the feedback suppression unit 20 and the feedback identification or recognition unit 21, the feedback events are determined, in which the feedback suppression unit 20 responds and/or in which the feedback identification unit 21 detects a feedback above a predeterminable feedback threshold. The frequency of the feedback events is determined within a predeterminable time period with a computing unit 23 connected to the event unit 22. If the determined frequency exceeds a predeterminable frequency threshold value, an acoustic signal is output through the receiver 3 by a signal unit 24 connected to the computing unit 23. The signal can optionally also be output optically and/or indicated to a remote controller of the hearing device 1 or displayed on the hearing device 1 itself, for instance.

In the case of hearing device wearers in need of care, the unpleasant consequences of hearing device feedback can thus be avoided by promptly informing a care giver of the hearing device wearer about changes to the feedback behavior, for instance. Thanks to an advance warning, it is possible to promptly allow new ear molds to be manufactured. A hearing device acoustician therefore need not take excessively drastic measures in terms of eliminating feedback (e.g. reducing the maximum amplification). When providing for children, it is very critical for childhood development if adjustment changes are needed specifically as a result of occurring feedbacks. The prediction according to the invention reliably prevents this.

1. A method for operating a hearing apparatus having at least one of feedback suppression responding upon occurrence of an acoustic feedback or acoustic feedback identification, the method comprising the following steps:
determining feedback events in which at least one of the feedback suppression responds or feedback is detected above a predeterminable feedback threshold value;
determining a frequency of the feedback events within a predeterminable duration; and
outputting a signal if the determined frequency exceeds a predeterminable frequency threshold value.

2. The method according to claim 1, wherein the frequency threshold value is less than a predeterminable acceptance value, and the frequency threshold value is determined from an interpolation of the acceptance value.

3. The method according to claim 2, which further comprises implementing the interpolation with the aid of a frequency distribution of the feedback events as a function of time, and extrapolating the frequency distribution up to the acceptance value.

4. The method according to claim 3, which further comprises determining an acceptance time instant on a basis of a curve of a frequency with which the acceptance value is reached.

5. The method according to claim 1, which further comprises emitting the signal acoustically or optically.

6. A computer software product stored on a memory executable by a control unit to perform the steps according to claim 1.

7. A hearing apparatus, comprising:
at least one of a feedback suppression unit responding upon occurrence of an acoustic feedback or an acoustic feedback identification unit;
an event unit for determining feedback events in which at least one of the feedback suppression responds or a feedback above a predeterminable feedback threshold value can be detected;
a computing unit for determining a frequency of the feedback events within a predeterminable time period; and
a signal unit for emitting a signal if the determined frequency exceeds a predeterminable frequency threshold value.

8. The hearing apparatus according to claim 7, wherein the frequency threshold value is less than a predeterminable acceptance value, and said computing unit is configured for determining the frequency threshold value from an interpolation of the acceptance value.

9. The hearing apparatus according to claim 8, wherein the interpolation in said computing unit can be implemented on the basis of a frequency distribution of the feedback events as a function of time, with the frequency distribution being extrapolated up to the acceptance value.

10. The hearing apparatus according to claim 9, wherein said computing unit is configured for determining, with the aid of a curve of the frequency, an acceptance time instant at which the acceptance value is likely to be reached.

11. The hearing apparatus according to claim 7, wherein said signal unit is configured for outputting the signal acoustically or optically.

12. The hearing apparatus according to claim 7, which further comprises a remote controller for emitting the signal.

13. The hearing apparatus according to claim 7, wherein the hearing apparatus includes an in-the-ear hearing device.
